(19) United States
(12) Patent Application Publication
(10) Pub. No.: US 2010/0127844 A1
(43) Pub. Date: May 27, 2010

(54) SEAT ALIGNMENT SENSING AND SAFEGUARDING MECHANISM OF AN ELECTRIC SCOOTER CART

(76) Inventor: Yung-Cheng CHEN, Jhongli City (TW)

Correspondence Address: EGBERT LAW OFFICES, 412 MAIN STREET, 7TH FLOOR, HOUSTON, TX, 77002, US

(21) Appl. No.: 12/277,304

(22) Filed: Nov. 25, 2008

(51) Int. Cl. B60Q 11/00

(52) U.S. Cl. 340/440; 297/217.3

(57) ABSTRACT

The present invention provides a seat alignment sensing and safeguarding mechanism of an electric scooter cart. The seat is assembled rotatably via the chassis onto the top of a column on the main body of the electric scooter cart. The first and second sensors are arranged correspondingly between the top of the column and the chassis of the seat. The first sensor on the column is electrically connected with a controller, which can control on/off state of the drive motor of the electric scooter cart according to the sensing signal of the first sensor. When the seat of the electric scooter cart isn't realigned, the electric scooter cart cannot be activated, thereby improving the operational safety of the electric scooter cart with better applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an electric scooter cart, and more particularly to an innovative scooter cart with an alignment sensing and safeguarding mechanism for the seat.

2. Description of Related Art Including Information Disclosed Under 37 CFR 1.97 and 37 CFR 1.98.

The existing electric scooter cart is structurally assembled in such a manner that the seat is generally provided with rotary angles in order to make the physically disabled or aged drivers get on/off the cart more conveniently. When a driver is intended for getting on/off the cart, the seat could be rotated 90° for facing laterally, or when a driver is intended for driving the cart, the seat could be readjusted and realigned to make the driver face the front of the cart and control correctly the driving direction.

However, due to the delayed reaction of the physically disabled or aged drivers, it is possible for them to trigger the throttle's deflector rod and activate the electric scooter cart by mistake when the seat is not yet realigned. Alternatively, any consequence or unexpected accident may occur due to their oblique gesture in sitting.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experiences in the production, development and design of related products.

### BRIEF SUMMARY OF THE INVENTION

Based on the unique structure of the present invention, the seat alignment sensing and safeguarding mechanism of electric scooter cart permits first and second sensors to be arranged correspondingly between the top of the column and the chassis of the seat. The first sensor is electrically connected with a controller, which can control the on/off state of the drive motor of the electric scooter cart according to the sensing signal of the first sensor. As compared with the prior art, when the seat of the electric scooter cart of the present invention is not realigned, the electric scooter cart cannot be activated, helping to prevent any unexpected hazard, and further improving the operational safety of the electric scooter cart with better applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the present invention, showing the seat separated from the column.

FIG. 2 shows a partial perspective view of the present invention.

FIG. 3 shows a schematic view of the present invention, showing the controller, magnetic reed switch and drive motor as electrically connected.

FIG. 4 shows a top plan view of the present invention, showing the seat in an aligned state.

FIG. 5 shows a top plan view of the present invention, showing the seat in a mis-aligned state.

### DETAILED DESCRIPTION OF THE INVENTION

The features and the advantages of the present inventionwill be more readily understood upon a thoughtful deliberation of the following detailed description of a preferred embodiment of the present invention with reference to the accompanying drawings.

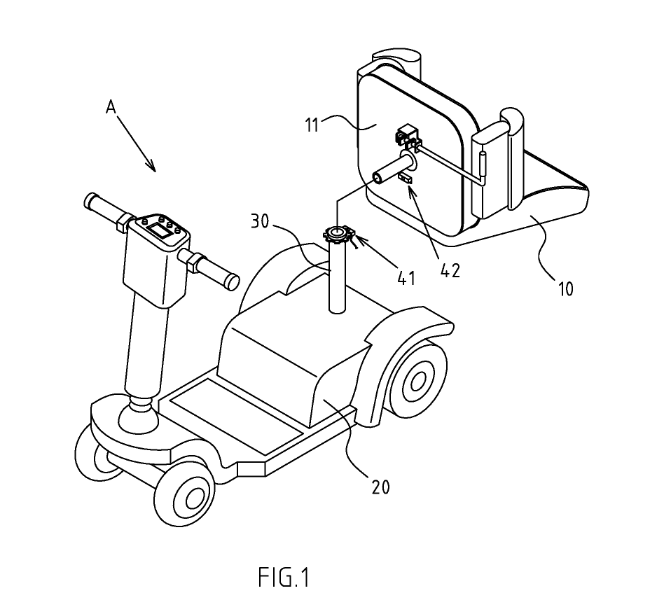

FIGS. 1-3 depict preferred embodiments of seat alignment sensing and safeguarding mechanism of an electric scooter cart of the present invention. The embodiments are only provided for explanatory purposes with respect to the patent claims.

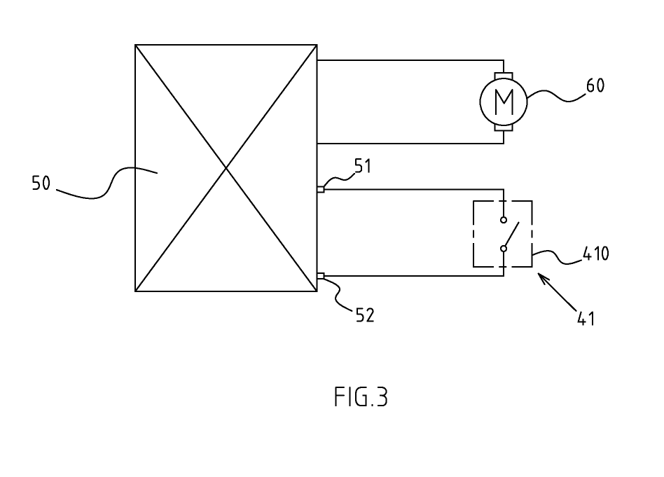

The seat 10 of electric scooter cart A is assembled rotatably via the chassis 11 onto the top of a column 30 on the main body 20 of the electric scooter cart A. A first sensor 41 and a second sensor 42 are arranged correspondingly between the top of column 30 and the chassis 11 of the seat 10. The first sensor 41 on the top of column 30 is electrically connected with a controller 50, so as to transmit signals to the controller 50 according to the sensing state. Meanwhile, the controller 50 can control on/off state of the drive motor 60 of the electric scooter cart A (shown in FIG. 3) according to the sensing signal of the first sensor 41.

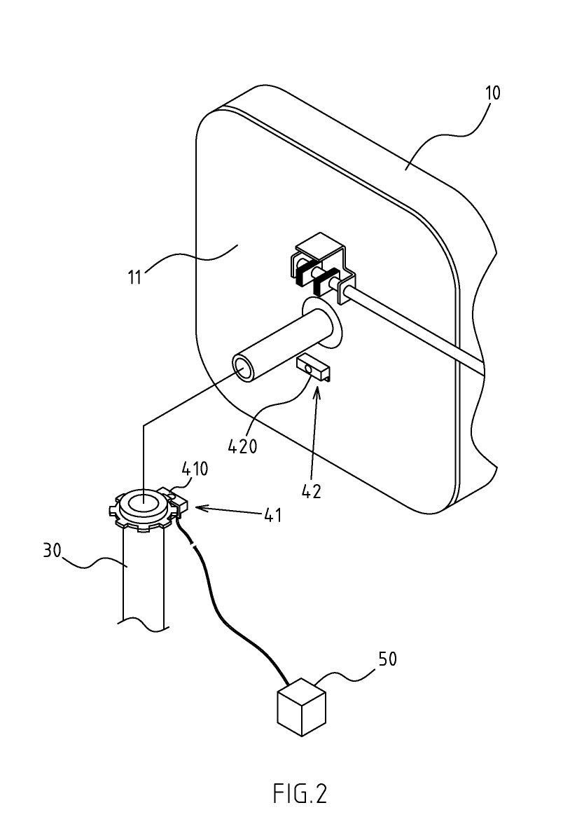

Referring to FIG. 2, the first sensor 41 is made of a magnetic reed switch 410, and the second sensor 42 is made of an induced magnet 420. The controller 50 (shown in FIG. 3) is provided with a signal contact 51 and earthing end 52, such that the magnetic reed switch 410 is wired to the signal contact 51 and earthing end 52 of the controller 50.

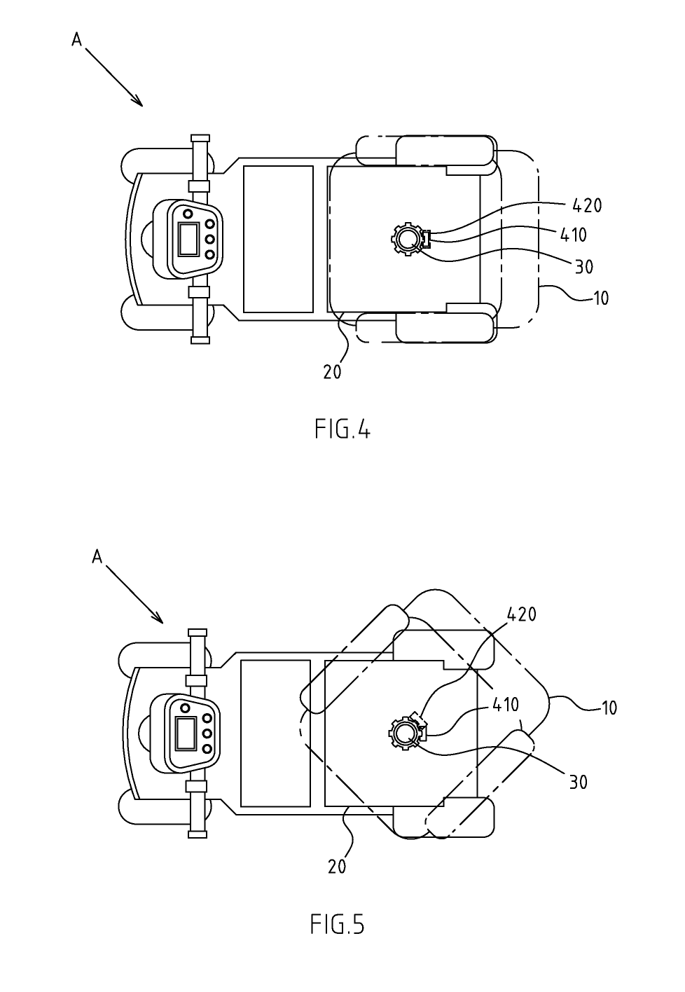

Based on the aforementioned structures, the seat alignment sensing and safeguarding mechanism of electric scooter cart A of the present invention is operated as shown in FIG. 4. When the seat 10 of the electric scooter cart A is under a preset positive angle (i.e. facing the cart head), the magnetic reed switch 410 is aligned with the induced magnet 420, and then induced by the magnet into an open-circuit state. In such case, the electronic signal of the controller 50 is high, representing normal starting state of the electric scooter cart A. When the seat 10 is deviated (shown in FIG. 5), the magnetic reed switch 410 is misaligned with the induced magnet 420, so the magnetic reed switch 410 is under a closed circuit state, and the signal of the controller 50 turns from high to low. Furthermore, the drive motor 60 is turned off to disable the electric scooter cart A. If users intend to resume the normal driving state, it is required to realign the seat 10 and reset the drive motor 60 without need of turning-on the power switch.

The deviation angle of the seat 10 is set as 15°. If this angle is exceeded, the motor control system will be cut off automatically, so that the motor of electric scooter cart A will be turned off immediately to avoid error triggering of the throttle. When the seat is realigned, the driver is allowed for normal operation with the throttle.

1. A seat alignment sensing and safeguarding mechanism of an electric scooter cart with a main body, comprising:
a column, protruded on the main body of an electric scooter cart;
a seat, containing a chassis, and being rotatably assembled on a top of the column;
a first sensor, being placed on top of the column;
a second sensor, being arranged on the chassis of the seat; and being in an alignment relationship with the first sensor depending o the rotation angle of the seat; and
a controller, being electrically connected with the first sensor; the controller can control and controlling an on/off state of the drive motor of the electric scooter cart according to the sensing signal of the first sensor.

2. The mechanism defined in claim 1, wherein the first sensor is comprised of a magnetic reed switch, the second sensor being comprised of an induced magnet, said controller being provided with a signal contact and earthing end, said magnetic reed switch being wired to the signal contact and earthing end of the controller, said magnetic reed switch being aligned with the induced magnet when said seat is under a present positive angle, and then induced by the magnet into an open-circuit state, said magnetic reed switch being misaligned with the induced magnet when said seat is deviated, said magnetic reed switch being under a closed circuit state, said controller having a signal turning from high to low, the drive motor being turned off to disable the electric scooter cart.
